(19) United States
(12) Patent Application Publication
(10) Pub. No.: US 2018/0012152 A1
(43) Pub. Date: Jan. 11, 2018

(54) DETERMINING A PASSENGER SERVICE PARAMETER FOR FLIGHT DISRUPTION

(71) Applicant: GE Aviation Systems LLC, Grand Rapids, MI (US)

(72) Inventors: Michael Arguello, Austin, TX (US); Charles Piet Ephraim, Grand Rapids, MI (US); Jonathan Mark Dunsdon, Murphys, CA (US); Leif Gerald Oines, Blanco, TX (US); Gordon Wayne Brush, Round Rock, TX (US); Steven Gregory, Round Rock, TX (US)

(21) Appl. No.: 15/642,575

(22) Filed: Jul. 6, 2017

Related U.S. Application Data
(60) Provisional application No. 62/359,952, filed on Jul. 8, 2016.

(51) Int. Cl. G06Q 10/02; G06Q 10/06; G06Q 50/30

(52) U.S. Cl. CPC G06Q 10/025; G06Q 50/30; G06Q 10/06312; G06Q 10/06315

(57) ABSTRACT

Systems and methods for determining a passenger service parameter for flight disruption are provided. A method can include receiving, by one or more processors, data indicative of user selection of flight disruption criteria. The method can further include determining, by the one or more processors, at least one impacted passenger based at least upon the data indicative of the user selection. The method can further include determining, by the one or more processors, an alternate flight accommodation for the at least one impacted passenger. The method can further include determining, by the one or more processors, a flight delay for the at least one impacted passenger based at least upon the alternate flight accommodation. The method can further include determining, by the one or more processors, a passenger service parameter associated the at least one impacted passenger based at least upon the flight delay.

### PRIORITY CLAIM

The present application claims the benefit of priority of U.S. Provisional Patent Application No. 62/359,952, entitled “DETERMINING PASSENGER SERVICE PARAMETER FOR FLIGHT DISRUPTION,” filed Jul. 8, 2016, which is incorporated herein by reference for all purposes.

### FIELD

The present subject matter relates generally to determining a passenger service parameter for a flight disruption, and more particularly, to determining a passenger service parameter for a flight disruption prior to the flight disruption occurring.

### BACKGROUND

An airline may need to disrupt a flight by cancelling or delaying the flight due to a variety of factors, such as inclement weather, aircraft availability, flight crew availability, airport conditions, or other factors. Typically, when an airline makes the decision to disrupt a flight, any passenger service parameters associated with the flight disruption are unknown. For example, an airline may have a policy to provide food, refreshments, lodging, transportation, and entertainment services to impacted passengers due to flight delays associated with the flight disruption. In some situations, these passenger service parameters can be significant, and can adversely impact an airline's customers' satisfaction and the airline's profitability. Further, in some situations in which a flight disruption is necessary, an airline may have several flight disruption options available, but may not know which flight would have the fewest impacted passengers and/or least passenger service parameters for flight disruption.

### BRIEF DESCRIPTION

Aspects and advantages of embodiments of the present disclosure will be set forth in part in the following description, or may be learned from the description, or may be learned through practice of the embodiments.

In one example embodiment, a system for determining a passenger service parameter for flight disruption includes one or more processors and one or more memory devices. The one or more memory devices store instructions that, when executed by the one or more processors, cause the one or more processors to perform operations. The operations can include receiving, by the one or more processors, data indicative of user selection of flight disruption criteria. In addition, the operations can include determining, by the one or more processors, at least one impacted passenger based at least upon the data indicative of the user selection. The operations can further include determining, by the one or more processors, an alternate flight accommodation for the at least one impacted passenger. In addition, the operations can include determining, by the one or more processors, a flight delay for the at least one impacted passenger based at least upon the alternate flight accommodation. The operations can also include determining, by the one or more processors, a passenger service parameter associated with the at least one impacted passenger based at least upon the flight delay.

In another example embodiment, a computer-implemented method of determining a passenger service parameter for flight disruption can include receiving, by one or more processors, data indicative of user selection of flight disruption criteria. The method can further include determining, by the one or more processors, at least one impacted passenger based at least upon the data indicative of the user selection. In addition, the method can include determining, by the one or more processors, an alternate flight accommodation for the at least one impacted passenger. The method can also include determining, by the one or more processors, a flight delay for the at least one impacted passenger based at least upon the alternate flight accommodation. In addition, the method can include determining, by the one or more processors, a passenger service parameter associated the at least one impacted passenger based at least upon the flight delay.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example user interface according to example aspects of the present disclosure;

FIG. 2 depicts an example method according to example aspects of the present disclosure;

FIG. 3 depicts a portion of an example method according to example aspects of the present disclosure;

FIG. 4 depicts a portion of an example method according to example aspects of the present disclosure;

FIG. 5 depicts a portion of an example method according to example aspects of the present disclosure;

FIG. 6 depicts a portion of an example method according to example aspects of the present disclosure; and

FIG. 7 depicts an example system according to example aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to systems and methods for determining a passenger service parameter associated with flight disruption. Flight disruptions, such as delays or cancellations, can occur due to a variety of reasons, such as inclement weather, aircraft availability, flight crew availability, airport conditions, or other factors. For example, an airline may need to delay a flight due to a scheduled maintenance operation taking longer than expected, thereby causing the airline to have fewer available aircraft than the number of flights scheduled for a particular time period. Similarly, an airline may need to cancel a flight when a member of a flight crew becomes ill, causing the airline to have fewer aircraft crews available than the number of flights scheduled during a particular time period. Rather than disrupt the particular flight that the impacted aircraft or flight crew was scheduled for, the airline may decide to reassign a flight crew or aircraft to another flight; thus the airline may have several options available when a decision to disrupt a flight is made. However, in such situations, the airline typically makes the decision to disrupt a particular flight without knowing the impact that the flight disruption will have on its booked passengers.

When a flight is disrupted, some passengers may experience flight delays due to the passengers being rescheduled on alternate flights. For example, a delay or cancellation may cause certain booked passengers to be unable to make a connecting flight. For passengers who have multiple connections, missing a first connection can have a cascading effect, which can increase the delay a particular passenger experiences. Further, for some passengers whose flights are disrupted, there may be not be any available flights to allow the passengers to reach their destination in a specified time-frame, such as, for example, within 24 hours of their scheduled arrival.

When a flight is disrupted, airlines will often provide passenger services to impacted passengers. For example, when a flight is disrupted, an impacted passenger may be booked on an alternate flight accommodation for the following day. In such a case, the airline may have a policy to provide certain passenger services to the impacted passenger. These passenger services can include, for example, refreshments, meals, lodging, transportation, and entertainment services. For example, an airline may provide vouchers for a meal, a hotel room, and taxi service to/from the airport for a passenger booked on an alternate flight accommodation for the following day.

Typically, when an airline makes a decision to disrupt a particular flight, the airline does not have any information regarding the impact that the flight disruption will have on the passengers booked on the flight. For example, an airline may not know whether any passengers will be unable to reach their final destination within a specified time period, and further, if so, how many such passengers will be impacted. Further, the airline may not know how many or what kind of passenger services will be needed by impacted passengers due to disrupting the flight. In certain situations, the passenger services provided by an airline due to flight disruption can be significant, and can cause passenger frustration and reduce an airline's profitability due to the airline providing passenger services.

The systems and methods according to example aspects of the present disclosure can allow for determining a passenger service parameter for flight disruption. For example, a user, such as an airline employee, can use a user interface to select one or more flights to be evaluated for disruption. For example, in an embodiment, the user can select one or more parameters to determine a list of flights to be considered for disruption by making flight search parameter selections on the user interface, such as, for example, by selecting a starting time period, an ending time period, a departing airport, an arrival airport, an aircraft type, an aircraft capacity, an occupancy level for the flight, or other parameters. In an embodiment, a user can select an individual flight by, for example, inputting a specific flight number or selecting the flight from a drop-down list displayed on the user interface.

Once a user has selected a flight or selected a set of flight search parameters for evaluating disruption, a processor can be configured to receive data indicative of the user's selection of flight disruption criteria. For example, a processor can be configured to receive data indicative of a specific flight, such as data indicative of a flight selected from a drop-down list displayed on the user interface. In an embodiment, the processor can be configured to receive data indicative of the user's selected flight search parameters, such as, for example, flights departing from a specific airport during particular time period. Based on the flight search parameters, the processor can determine a list of flights that fit the flight search parameters by, for example, accessing a flight database and selecting flights that meet the search parameters.

The processor can be further configured to determine at least one impacted passenger based on the data indicative of the user selection of flight disruption criteria. For example, the processor can be configured to determine that a particular passenger will be impacted by the disruption if a passenger was booked on a particular flight being considered for flight disruption. For example, a processor can be configured to access a passenger list for the flight(s) selected by the user and/or the user's flight disruption criteria. As used herein, the phrase “passenger list” can refer to any means of tracking individuals who are booked on a particular flight, and can include, for example, information regarding a passenger's originating airport, flight destination, connecting flights, fare class, travel companions, a count of passengers on a flight, a seat occupancy status, a count of passengers booked on a subsequent connecting flight or flights, and other information. A passenger list need not necessarily include passenger names.

The processor can be further configured to determine an alternate flight accommodation for the at least one impacted passenger. For example, the processor can be configured to determine the passenger's destination from the passenger list associated with the flight considered for disruption. The processor can be configured to determine a list of alternate flights to the impacted passenger's destination with a threshold time period, such as, for example, 24 hours, by accessing a list of flights including direct and connecting flights to the destination. The processor can be configured to select a flight from the list of alternate flights, determine if there is an available seat on the flight, and if so, fill the seat with the impacted passenger. If no space is available, the processor can be configured to return to the list of flights to select another flight, and repeat the process until an available seat is found for the impacted passenger. If no space on any flight is available within the specified time period, the processor can be configured to add the passenger to a “spill list,” which is a list of passengers who cannot be accommodated within the specified time period. Further, in an embodiment, the processor can be configured to determine if the passenger is flying in a group of travel companions, and if so, the processor can be configured to select an alternate flight accommodation such that the group is added to the same flight. In an embodiment, the passenger need not actually be booked on the alternate flight accommodation. Rather, the processor can add the passenger to a separate passenger list for purposes of determining alternate flight accommodations for each impacted passenger.

The processor can be further configured to determine a flight delay for the at least one impacted passenger based on the alternate flight accommodation. For example, an impacted passenger may be added to an alternate flight accommodation that is scheduled to arrive at the passenger's destination at a later time than the passenger's original flight. The processor can be configured to determine a flight delay based on the time difference between the scheduled arrival time of the original flight and the scheduled arrival time of the alternate flight accommodation.

The processor can be further configured to determine a passenger service parameter associated with the at least one impacted passenger based at least on the flight delay. For example, an impacted passenger may experience an overnight delay due to a flight disruption if the impacted passenger is booked on an alternate flight accommodation departing the next morning. The airline may have a policy in which the airline provides certain passenger services based on a flight delay. For example, an airline may have a policy to provide a meal and/or refreshments if an impacted passenger is delayed for a period of time that exceeds a threshold, such as, for example, four hours. Similarly, an airline may have a policy to provide lodging to an impacted passenger if the impacted passenger is delayed for a period of time that exceeds a threshold, such as, for example, an overnight delay. Similarly, the airline may have policies for providing transportation, entertainment, and/or other services for delays exceeding specific thresholds. The processor can be configured to determine which, if any, passenger services will be needed for an impacted passenger based on the airline's policy and the impacted passenger's flight delay. For example, the processor can be configured to compare the impacted passenger's flight delay to specified thresholds, and if the delay exceeds the threshold, then the processor can add those passenger services to a passenger service parameter. The passenger service parameter can be represented by, for example, counts of impacted passengers in specific categories, such as passengers needing lodging, or any other suitable means of tracking the passenger services.

In an embodiment, the processor can be configured to determine a passenger service parameter associated with a potential flight disruption for the entire flight by determining a passenger service parameter for each impacted passenger booked on the evaluated flight. In an embodiment, the processor can be configured to determine a passenger service parameter associated with a potential flight disruption for groups of passengers, such as passengers travelling together or groups of passengers on a particular connecting flight. In an embodiment, the processor can be configured to determine a passenger service parameter for each flight evaluated for a flight disruption based on the user's selection of flight disruption criteria, such as, for example, each flight that matches a user's selected flight disruption criteria. In an embodiment, the processor can be configured to determine a passenger service parameter associated with a flight disruption prior to the flight disruption occurring.

Further, the processor can be configured to output the passenger service parameter to the user. For example, the passenger services for each potentially disrupted flight can be displayed on the user interface to allow the user to view the impact of a potential flight disruption. This can further allow a user to evaluate potentially disrupted flights against each other, and can allow the user to make a determination regarding which flight to disrupt based on the impact the flight disruption will have on impacted passengers. Further, in an embodiment, the passenger service parameter can be output to the user with additional information to be used in determining a flight disruption, such as, for example, information regarding the flight disruption statistics, revenue information, passenger connections, number of passengers, spilled passengers, or other information for a particular flight.

In this way, the systems and methods according to example aspects of the present disclosure can allow for determining a passenger service parameter associated with a flight disruption, and more particularly, determining a passenger service parameter for a list of potentially disrupted flights prior to a flight disruption occurring. The example systems and methods of the present disclosure can have a technical effect of providing a user making a flight disruption decision with additional information regarding the impact a flight disruption will have on the passengers booked on a potentially disrupted flight, and further can allow the user to determine the passenger services that will be needed due to a potential flight disruption. This can allow the user to make an informed decision, potentially reducing airline customer frustration and dissatisfaction, and allowing the airline to reduce the amount of passenger services needed due to a flight being disrupted.

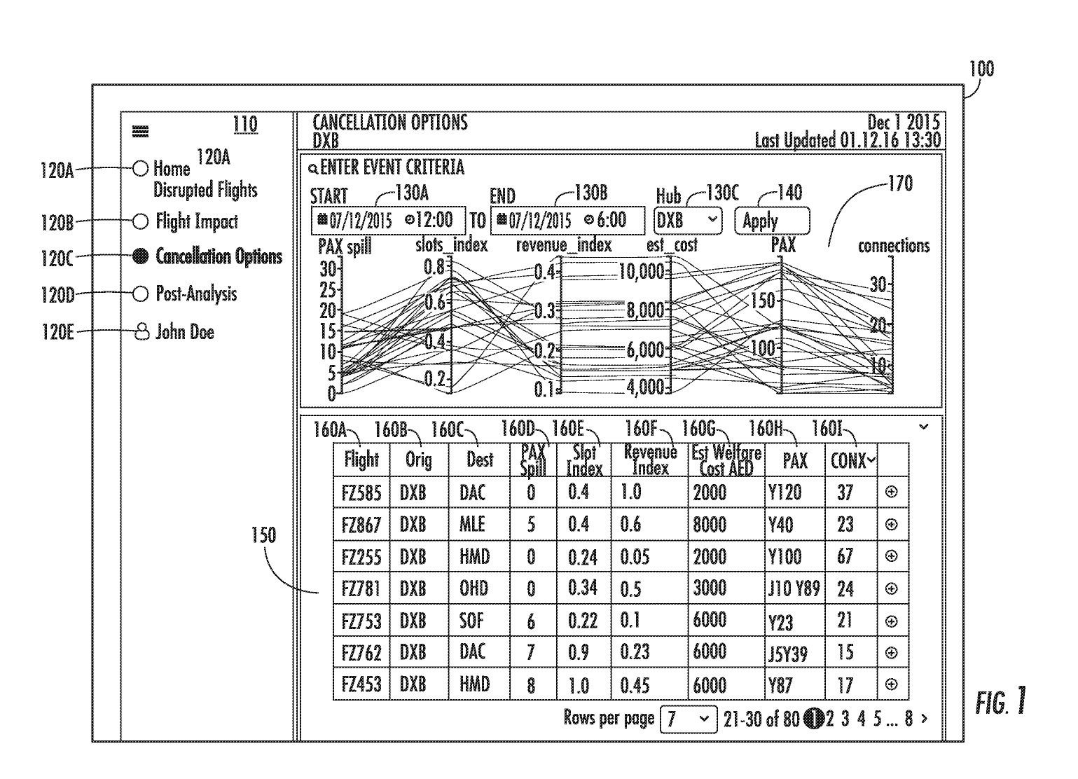

With reference now to the FIGS., example embodiments of the present disclosure will be discussed in further detail. FIG. 1 depicts a user interface 100 according to example aspects of the present disclosure. As depicted, the user interface 100 can be displayed on a display device, such as a display device operatively connected to a computing device. The user interface 100 can include a menu 110 to allow a user to navigate through one or more tabs 120. Each tab 120 can be associated with, for example, a different feature or flight evaluation option. For example, as depicted on FIG. 1, a first tab 120A can be associated with a home screen, a second tab 120B can be associated with a flight impact screen, a third tab 120C can be associated with a cancellation options screen, a fourth tab 120D can be associated with a post-analysis screen, and a fifth tab 120E can be associated with a user profile. As depicted in FIG. 1, a cancellation options tab 120C is displayed in the user interface 100.

The user interface 100 can allow a user to interact with a computing system by, for example, navigating through the tabs 120 to allow a user to select search criteria for evaluating a flight disruption. For example, a user may desire to evaluate potential flight disruptions due to an aircraft needing to be taken out of service for maintenance. Because the aircraft may have been scheduled to be used for a particular flight from a specific airport at a particular time, the user may desire to evaluate flight disruption options for flights departing from the same airport during a specified time period. Using the user interface 100, the user can enter appropriate flight disruption search criteria to evaluate flight disruption options.

For example, in an embodiment, a tab 120C in a user interface 100 can include one or more input fields 130 to allow a user to enter flight disruption search criteria. For example, a first input field 130A can allow a user to enter a starting time period to search for flights. A second input field 130B can allow a user to enter an ending time period for the flight search. A third input field 130C can allow a user to enter a hub, or airport from which flights are departing. In an embodiment not depicted in FIG. 1, a user interface 100 can include a field to enter a particular flight number to be evaluated. Further, in an embodiment not depicted in FIG. 1, a user can enter other flight search criteria, such as, for example, an arrival airport, an aircraft type, an aircraft capacity, an occupancy level for the flight, or other parameters. Further, in an embodiment, a user interface can be configured to allow a user to enter a type of flight disruption, such as, for example, delaying a flight or cancelling a flight. A user interface 100 can further include a flight search button 140, which a user can select to initiate a flight search based on the user's selections in the input fields 130.

A processor, such as a processor in a computing device, can be configured to receive data indicative of a user selection of flight disruption criteria. For example, the processor can be configured to receive the flight search criteria input by a user into a user interface 100 after a user selects a flight search button 140. For example, the processor can receive a first flight disruption search criterion, such as a starting time period to search for flights input into a first input field 130A. The processor can further receive a second flight disruption search criterion, such as an ending time period for the flight search input into a second input field 130B. The processor can further receive a third flight disruption search criterion, such as an airport hub input into third input field 130C. Additionally and/or alternatively, the processor can be configured to receive data indicative of any user selection of flight disruption criteria, such as a specific flight, or other flight search criteria.

Based on the user selection of flight disruption criteria, the processor can be configured to determine flights that fit the user selection of flight disruption criteria. For example, a processor can be configured to access a database of flights operated by an airline. The database can include information regarding, for example, a flight number, passenger list, an originating airport, a destination airport, a scheduled departure time, a scheduled arrival time, any passenger connections, and other flight information. The processor can be configured to determine flights meeting the user selection of flight disruption criteria using known methods, such as accessing a lookup table of flights and filtering the table based on the user selection of flight disruption criteria.

Referring still to FIG. 1, the processor can be configured to display flights that match the user selection of flight disruption criteria in the user interface 100. For example, a user interface 100 can include a search results display field 150. The search results display field 150 can include, for example, flights matching the user selection of flight disruption criteria input into the input fields 130.

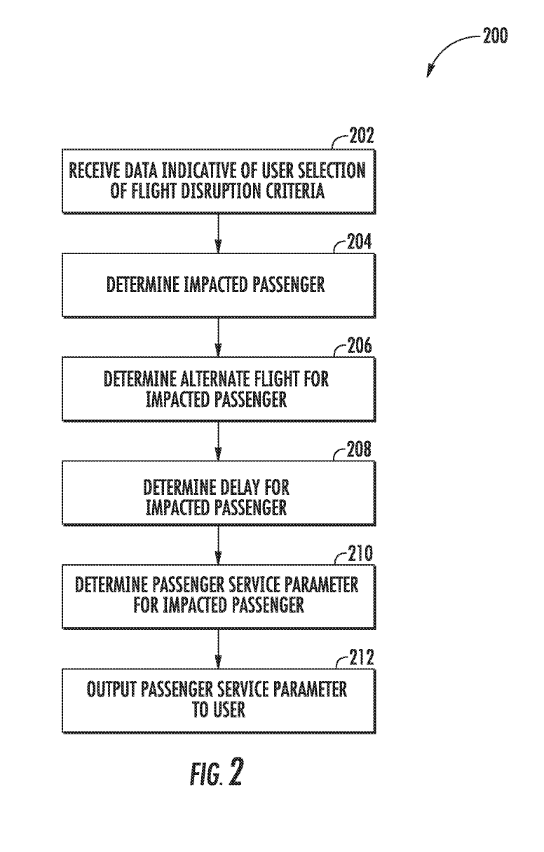

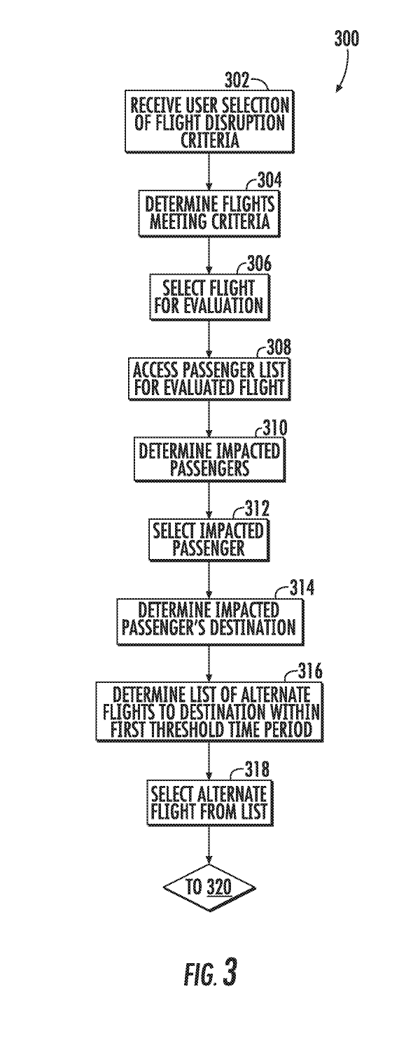

As will be discussed in greater detail with respect to FIGS. 2 and 3, the processor can be further configured to determine a passenger service parameter associated with a flight disruption. For example, a processor can be configured to determine an impacted passenger based on the user selection of flight disruption criteria, by, for example, accessing a passenger list of a flight meeting the flight disruption criteria. The passenger list can include passengers booked on the potentially disrupted flight. Further, the processor can be configured to determine an alternate flight accommodation for the impacted passenger. The processor can be further configured to determine a flight delay for the impacted passenger based on the alternate flight accommodation. The processor can be further configured to determine a passenger service parameter associated with the impacted passenger based on the flight delay. The processor can be further configured to determine a passenger service parameter for every passenger on a flight, and further configured to determine a passenger service parameter for every flight meeting a user selection of flight disruption criteria.

Referring still to FIG. 1, the processor can be configured to output flight information in the user interface 100. For example, the processor can be configured to output the passenger service parameter associated with a flight disruption to a user by displaying the passenger service parameter in a column in the search results field display 150. For example, the search results display field 150 can include one or more flight parameters 160. For example, a first flight parameter 160A can be a flight number, a second flight parameter 160B can be a originating airport code, a third flight parameter 160C can be a destination airport code, a fourth flight parameter 160D can be a spilled passenger count, a fifth flight parameter 160E can be a slot index associated with a metric for determining how often a flight is disrupted, a sixth flight parameter 160F can be associated with a revenue index such as a revenue metric, a seventh flight parameter 160G can be associated with a passenger service parameter, such as a cost associated with passenger services to be provided to impacted passengers, an eighth flight parameter 160H can be a passenger count and cabin class, and a ninth flight parameter 160I can be a connecting passenger count. Additional flight parameters can be displayed in a user interface 100 as well. The processor can be configured to determine, for example, a passenger search parameter for each flight, and display the passenger service parameter in the flight parameter 160G. As shown FIG. 1, the passenger service parameter can be a cost associated with all passenger services to be provided to impacted passengers for an entire flight. However, other passenger service parameters can similarly be displayed, such as a count of passengers needing specific passenger services, such as food, refreshments, lodging, transportation, entertainment, or other passenger service parameters.

In another embodiment, the information reported in the search results display field 150 can be displayed in a graphical format in a flight graph 170 of a user interface 100. For example, as depicted in FIG. 1, a plurality of individual flights is represented by separate lines. Each line represents a relative value for a number of spilled passengers (PAX Spill), a slot index (slots_index), a revenue index (revenue_index), a flight services parameter (est_cost), a number of passengers (PAX), and a number of connecting passengers (connections). In this way, a user can be provided a quick visual reference showing the relative values of several flight parameters for one or more flights.

A user, such as an airline employee making a flight disruption decision, can view the information displayed in a user interface 100 in order to make a decision about which flight to disrupt. For example, a user can make a decision to disrupt a flight that would result in the fewest spilled passengers. A user could similarly decide to disrupt a flight that required the fewest passenger services, which could be determined based on a count of one or more specific passenger service parameters, an aggregate cost associated with passenger services needed for impacted passengers on a disrupted flight, or other flight service parameters. Further, if additional flight parameters are displayed, such as slot index, revenue index, or a passenger count, the user can consider these other parameters in conjunction with the passenger service parameters. This may be advantageous if, for example, a slot index indicates that a particular flight has a history of disruptions that could cause a regulatory body to determine the airline should not be allowed to continue operating the flight. In such a case, the user may decide that a particular flight is a poor candidate for flight disruption, and instead opt for another flight. In this way, the systems and methods of the present disclosure can have a technical effect of allowing a user to make an informed decision regarding flight disruptions prior to the flight disruption occurring.

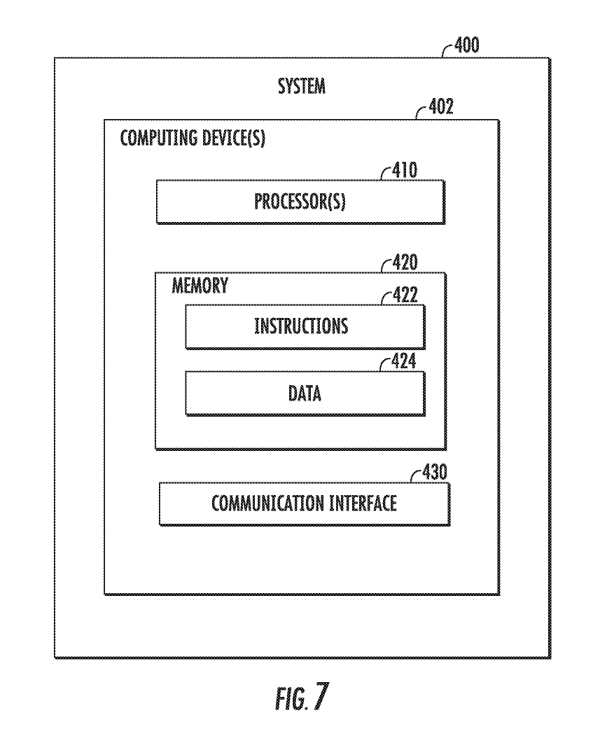

Referring now to FIG. 2, a flow diagram of an example method (200) according to example embodiments of the present disclosure is depicted. The method (200) can be implemented by one or more processors, such as a processor 410 of a system 400 depicted in FIG. 7. In addition, FIG. 2 depicts steps performed in a particular order for purposes of illustration and discussion. Those of ordinary skill in the art, using the disclosures provided herein, will understand that the various steps of any of the methods disclosed herein can be modified, adapted, expanded, rearranged and/or omitted in various ways without deviating from the scope of the present disclosure.

At (202), the method (200) can include receiving, by one or more processors, data indicative of a user selection of flight disruption criteria. For example, a user, such as an airline employee, can select search criteria in order to evaluate one or more flights for a potential disruption. For example, a user can input a starting period for a search, an ending period for a search, and an airport from which flights depart into a user interface, such as a user interface depicted in FIG. 1. In an embodiment, a user can select an individual flight to evaluate, such as, for example, by entering a flight number into a user interface or selecting a flight from a drop-down menu. The processor can receive the user selection of flight disruption criteria by, for example, the user entering the flight search criteria by selecting a flight search button 140. The data indicative of a user selection can be, for example, the flight search criteria or other data input by a user.

At (204), the method can include determining, by the one or more processors, at least one impacted passenger based at least upon the data indicative of the user selection. For example, a user can select a flight from a drop down menu in a user interface, such as a user interface 100 depicted in FIG. 1. The processor can be configured to access a passenger list associated with the flight by, for example, accessing one or more databases in communication with the one or more processors. The processor can be configured to determine at least one impacted passenger from the passenger list based on the flight disruption type, such as a flight cancellation. In an embodiment, the processor can be configured to determine at least one impacted passenger on more than one flight, such as, for example, a list of flights matching a user's flight selection criteria. For example, a user could select search criteria that corresponded to two or more flights, such as two flights departing from a particular airport during a specified time period. The processor can be configured to determine at least one impacted passenger for each flight by, for example, accessing a passenger list associated with each flight.

At (206), the method (200) can include determining, by the one or more processors, an alternate flight accommodation for the at least one impacted passenger. For example, a processor can obtain information from a passenger list for an impacted passenger, including information regarding the passenger's final destination, connecting flights, travel companions, or other information. Based on the impacted passenger information, the one or more processors can be configured to determine an alternate flight accommodation by, for example, accessing a list of direct and/or connecting flight segments that would allow the impacted passenger to reach the impacted passenger's destination within a specified time period. For example, a processor could access a database of flights, search for flights or flight combinations in a specific time period, and select a flight for the impacted passenger. In an embodiment, the one or more processors can be further configured to determine an alternate flight accommodation for each impacted passenger in a group of travelling companions by, for example, searching for flights with available seats for each person in the group. Further, in an embodiment, if no alternate flight accommodations have available capacity for the impacted passenger and/or the impacted passenger's travelling companions, the one or more processors can be configured to determine that the passenger and/or travelling companions are spilled passenger(s). In an embodiment, one or more algorithms can be used to determine an alternate flight accommodation for an impacted passenger, such as, for example, by selecting a flight to reduce a flight delay, or reduce a number of spilled passengers.

At (208), the method (200) can include determining, by the one or more processors, a flight delay for the at least one impacted passenger based at least upon the alternate flight accommodation. For example, a processor can be configured to determine a flight delay by determining a difference between a scheduled arrival time for the alternate flight accommodation and the scheduled arrival time for the impacted passenger's original flight.

At (210), the method (200) can include determining, by the one or more processors, a passenger service parameter associated with the at least one impacted passenger based, at least in part, upon the flight delay. For example, an airline may have a policy to provide certain passenger services to passengers impacted by a flight disruption when the flight delays exceed certain thresholds. For example, if an impacted passenger's flight delay exceeds a first threshold, the airline's policy can include providing refreshments and/or meals to the impacted passenger. Similarly, if a flight delay extends overnight, an airline may have a policy of providing lodging and/or transportation services to the impacted passenger. The one or more processors can be configured to determine a passenger service parameter by, for example, determining whether the impacted passenger's flight delay exceeds one or more thresholds for various passenger services. If so, the processor can determine that those respective passenger services are needed for the impacted passenger, and the processor can include those passenger services in a parameter to be reported to the user. For example, in an embodiment, a processor can determine a passenger service parameter by determining that one or more passenger services is needed by the at least one impacted passenger. In another embodiment, the one or more processors can determine which passenger services are needed for each impacted passenger on a flight, and determine the total number of impacted passengers needing different categories of passenger services. In yet another embodiment, the one or more processors can determine a cost associated with the passenger services needed by an impacted passenger by, for example, determining which passenger services are needed for an impacted passenger, and summing the costs of those services. Similarly, the one or more processors can determine an aggregate cost for all passenger services for all impacted passengers on a disrupted flight.

At (212), the method (200) can include outputting, by the one or more processors, the passenger service parameter to the user. For example, the one or more processors can send one or more signals to a display device in communication with the one or more processors to display the parameter. For example, a passenger services parameter can be displayed in a flight parameter 160 in a search results display field 150 of a user interface 100.

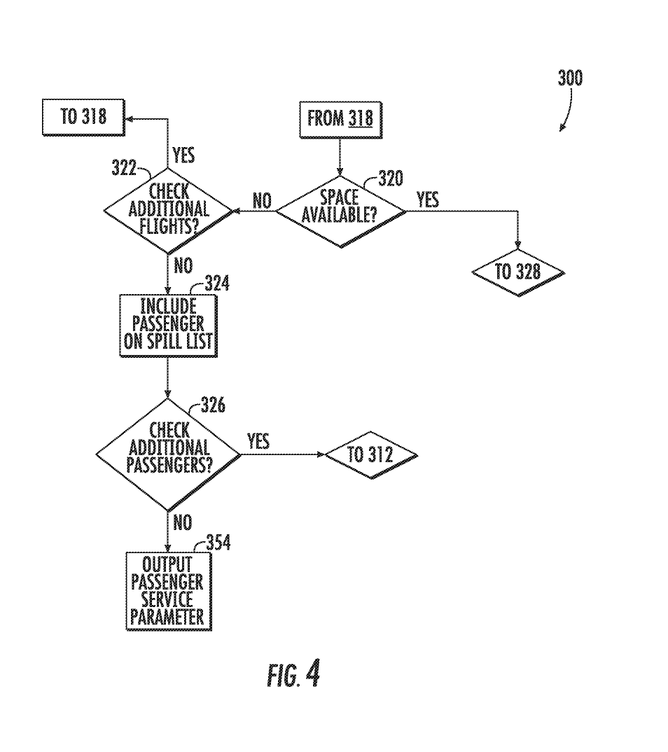

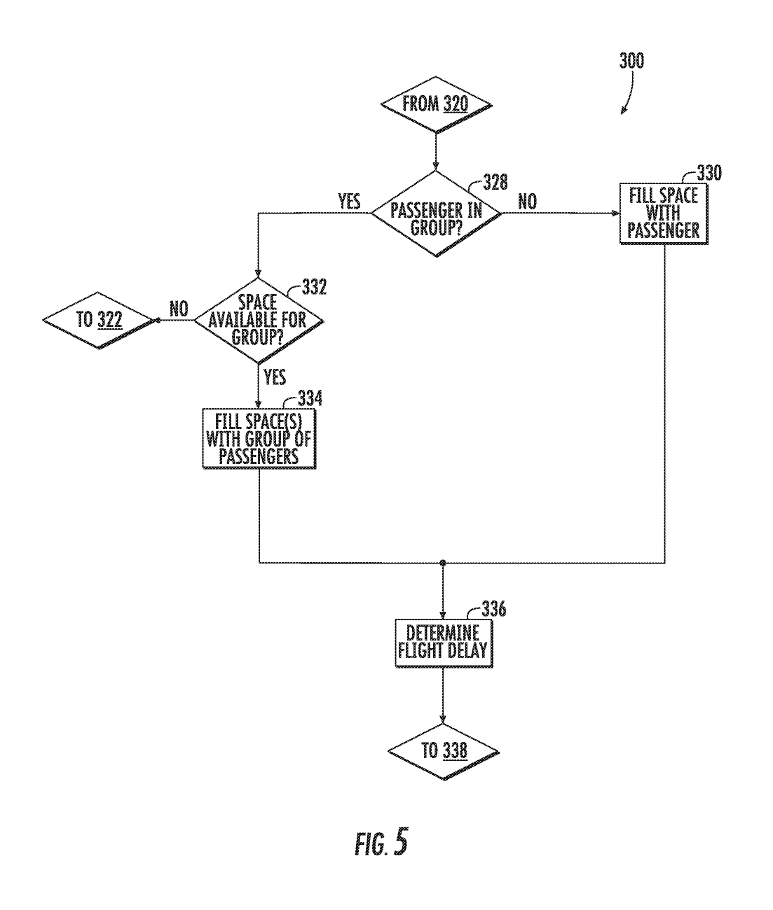

Referring now to FIG. 3 through 6, a method (300) according to example embodiments of the present disclosure is depicted. The method (300) can be used, for example, to determine a flight service parameter associated with a flight disruption, similar to the method (200).

At (302), the method (300) can include receiving, by one or more processors, data indicative of a user selection of flight disruption criteria. For example, a user, such as an airline employee, can select search criteria in order to evaluate one or more flights for a potential disruption. For example, a user can input a starting period for a search, an ending period for a search, and an airport from which flights depart into a user interface, such as the user interface 100 depicted in FIG. 1. In an embodiment, a user can select an individual flight to evaluate, such as, for example, by entering a flight number into a user interface or selecting a flight from a drop-down menu. The processor can receive the user selection of flight disruption criteria by, for example, the user entering the flight search criteria by selecting a flight search button 140. The data indicative of a user selection can be, for example, the flight search criteria or other data input by a user. In an embodiment, the user can input flight search criteria prior to any flight disruption decision being made. For example, the user can select input criteria in a user interface 100 to allow the user to evaluate several flight disruption options to enable the user to make an informed decision as to which flight, if any, to disrupt.

At (304), the method (300) can include determining one or more flight(s) that matches the user's selection of flight disruption criteria. For example, the one or more processors can be configured to access one or more flight databases. The one or more flight databases can be, for example, a local flight database stored on a computing device, such as a computing device in system 400 depicted in FIG. 7. Additionally and/or alternatively, the one or more flight databases can be one or more flight databases in communication with the one or more processors over a network. Based on the flight search parameters input by the user, the processor can determine a list of flights that fit the flight search parameters by, for example, accessing a lookup table and selecting flights that meet the search parameters.

At (306), the method (300) can include selecting a flight for evaluation. For example, the user's flight search criteria may return more than one flight, such as when a user searches for flights departing from a particular airport during a specified period of time. In such a case, the one or more processors can select a flight for flight disruption evaluation. In an embodiment, the method (300) can be performed for each flight matching the user's selection of flight disruption criteria. For example, the method (300) can be performed for a first flight meeting the flight disruption criteria, then a second flight meeting the flight disruption criteria, and each successive flight until the method (300) has been performed for all flights meeting the flight disruption criteria. In the case that the user selects a particular flight, or only one flight matches the user's flight disruption criteria, the processor can select the flight for evaluation.

At (308), the method can include accessing, by one or more processors, a passenger list for the flight being evaluated. For example, the one or more processors can be configured to access a passenger list associated with a selected flight by, for example, accessing one or more passenger databases. The one or more passenger databases can be, for example, a local passenger database stored on a computing device, such as a computing device in system 400 depicted in FIG. 7. Additionally and/or alternatively, the one or more passenger databases can be one or more passenger databases in communication with the one or more processors over a network. The passenger list can contain information, such as individual passengers, groups of passengers, or passengers booked on subsequent connecting flights.

At (310), the method (300) can include determining at least one impacted passenger from the passenger list. The one or more processors can be configured to determine at least one impacted passenger from the passenger list based on the flight disruption type, such as a flight cancellation. For example, if a flight is being considered for a cancellation, the one or more processors can be configured to determine that an impacted passenger will not be able to reach their final destination if the flight is cancelled. Further, if a flight is being considered for a delay for a specified period of time, the one or more processors can be configured to determine that a passenger with a connecting flight will not be able to reach their flight destination if the delay exceeds the passenger's layover time. In this way, the one or more processors can determine if one or more passengers are “impacted passengers” due to the potential flight disruption. The one or more processors can create a list of impacted passengers. In an embodiment, the one or more processors can be configured to determine that each passenger in a group of passengers or a count of passengers on a connecting flight is an impacted passenger. For example, the one or more processors can be configured to determine that a count of passengers on a particular connecting flight will not make their connecting flight due to a disruption, and thus can include the entire count of passengers on the impacted passenger list.

At (312), the one or more processors can be configured to select an impacted passenger from the impacted passenger list. In an embodiment, the method (300) can be performed for each impacted passenger on a flight being considered for disruption. For example, the method (300) can be performed for a first impacted passenger, a second impacted passenger, and each successive impacted passenger until all the method (300) has been performed for all impacted passengers on a particular flight. In an embodiment, the one or more processors can be configured to select a group of passengers from the passenger list, such as a group of travelling companions or a group of passengers who are all booked on the same connecting flight.

At (314), the method (300) can include determining a destination for an impacted passenger. For example, the one or more processors can be configured to access certain information associated with a selected impacted passenger. For example, the passenger list contained on a passenger database can contain information regarding the passenger's final destination, connecting flights, travel companions, or other information. The one or more processors can be configured to access this information to determine an impacted passenger's destination.

At (316), the method (300) can include determining a list of alternate flights to the impacted passenger's destination within a first threshold time period. For example, the one or more processors can be configured to determine an alternate flight accommodation by, for example, accessing a list of direct and/or connecting flight segments that would allow the impacted passenger to reach the impacted passenger's destination within a specified time period. For example, a processor could access one or more databases of available flights, search for flights or flight combinations in a specific time period, and select a flight for the impacted passenger. In an embodiment, the database of alternate flights can be a database of alternate flights for the same airline. In another embodiment, the database of alternate flights can be any database of alternate flights, and can include flights operated by other airlines. The one or more available flight databases can be, for example, one or more local available flight databases stored on a computing device, such as a computing device in system 400 depicted in FIG. 7. Additionally and/or alternatively, the one or more available flight databases can be one or more available flight databases in communication with the one or more processors over a network. The first threshold time period can be, for example, a time period specified by the user. For example, an airline may choose to use a 24 hour time period for determining alternate flight accommodations. If an impacted passenger cannot be placed on an alternate flight accommodation within the specified time period, the impacted passenger may be considered a spilled passenger.

At (318), the method (300) can include selecting an alternate flight accommodation from the list of alternate flights. For example, the one or more processors can be configured to select an alternate flight accommodation from the list of alternate flights based on one or more user preferences. For example, the one or more processors can be configured to first select an alternate flight accommodation with the shortest delay or the greatest available capacity. Additionally and/or alternatively, other flight selection methods or preferences can be used.

At (320), the method (300) can include determining whether space for the impacted passenger is available on the selected alternate flight accommodation. For example, the one or more processors can determine whether space is available based on the current booked capacity of the alternate flight accommodation by accessing one or more passenger lists associated with the alternate flight accommodation.

If space is not available on the alternate flight accommodation, at (322) the method can include checking whether additional alternate flights are on the list of alternate flights. For example, the one or more processors can be configured to check if space is available for an impacted passenger on a first flight at (320), and if not, the one or more processors can be configured to return to (318) to select a second flight from the list of alternate flights.

If, at (322), no additional flights remain on the list of alternate flights, at (324) the one or more processors can be configured to add the impacted passenger to a “spill list,” which can include all spilled passengers. The spilled passengers can be output to a user, such as in a parameter field 160 in a user interface 100 as shown in FIG. 1. Once the impacted passenger has been added to the spill list, at (326), the method can include checking if additional passengers are on the impacted passenger list. If so, the method can return to (312) to select another passenger. If at (326) no additional passengers are on the passenger list, the one or more processors can output the passenger service parameter at (354).

Returning to (320), if space is available for an impacted passenger on an alternate flight, (at 328) the one or more processors can check to see if the impacted passenger is travelling in a group. The one or more processors can determine if the impacted passenger is travelling in a group by checking to see if the impacted passenger has any travelling companions by accessing the passenger database.

If the impacted passenger is not travelling in a group, (at 330) the one or more processors can fill the space on the alternate flight accommodation with the impacted passenger. For example, the one or more processors can store a local passenger list on one or more data storage devices, which can include a list of all passengers listed on an alternate flight accommodation in the list of alternate flights. The one or more processors can fill a vacant seat with the impacted passenger in the list in the local passenger list. In an embodiment, the one or more processors can book the impacted passenger on the alternate flight. However, in another embodiment, the one or more processors can add the impacted passenger to the local passenger list and not book the passenger on the alternate flight accommodation. In this way, the one or more processors can continue with the method (300) to determine if space is available for every impacted passenger, without booking the impacted passengers on alternate flights, thereby allowing a user to determine the effects of disrupting a flight before the flight is actually disrupted.

Returning to (328), if the impacted passenger is travelling with companions, at (332) the one or more processors can check if space is available on the alternate flight accommodation for the group of passengers. If space is available for the group, similar to the method at (330), at (334), the one or more processors can fill the space(s) with the group of passengers. As with (330), the one or more processors can store a local passenger list. Further, once the space(s) on the alternate flight accommodation have been filled by the group of impacted passengers, the one or more processors can remove the group of passengers from the list of impacted passengers. If, at (332), no space is available for the group of passengers, the one or more processors can return to (322) to check if additional flights are available.

Returning to (334) and (330), once the space(s) on an alternate flight accommodation have been filled with the impacted passenger(s), at (336), the one or more processors can determine a flight delay for the one or more impacted passengers. For example, the one or more processors can be configured to determine a flight delay by determining a difference between a scheduled arrival time for the alternate flight accommodation and the scheduled arrival time for the impacted passenger's original flight.

At (338), the one or more processors can check whether the flight delay exceeds a second threshold. For example, an airline may have a policy to provide certain passenger services to passengers impacted by a flight disruption when the flight delays exceed certain thresholds. The second threshold can be, for example, a time period of 6 hours. Additionally and/or alternatively, the second threshold can be any period of time. Further, in an embodiment, the second threshold can be set by a user, such as an airline or an airline employee. For example, a second threshold can be set such that if a flight delay exceeds the second threshold (e.g., 6 hours), the airline can provide refreshments to the impacted passenger. The refreshments can be, for example, snacks or a meal. In an embodiment, multiple thresholds can be set such that various refreshments are provided if the delay exceeds each threshold.

If the flight delay of the impacted passenger(s) does not exceed the second threshold, at (326), the one or more processors can check to see if there are additional passengers on the spill list. If, however, the flight delay of the impacted passenger (s) does exceed the second threshold, at (340), the one or more processors can include a refreshment count or indicator in the passenger service parameter. For example, the passenger service parameter can be a count of passengers needing a particular passenger service. The one or more processors can be configured to maintain a list or count of impacted passengers needing a particular service, and can include that service in a passenger service parameter.

Once the refreshment has been included in the passenger service parameter at (340), the one or more processors can, at (342), check if the flight delay exceeds a third threshold. The third threshold can be, for example, a threshold associated with providing lodging. For example, if a flight delay extends overnight, an airline may have a policy of providing lodging to the impacted passenger. Additionally and/or alternatively, the third threshold can be any period of time. Further, in an embodiment, the third threshold can be set by a user, such as an airline or an airline employee. The one or more processors can be configured to determine a passenger service parameter by, for example, determining whether the impacted passenger's flight delay exceeds the third threshold. If the flight delay of the impacted passenger(s) does not exceed the third threshold, the one or more processors can, at (326) check to see if there are additional passengers on the spill list. If, however, the flight delay of the impacted passenger(s) does exceed the third threshold, the one or more processors can, at (344) include a lodging count or indicator in a passenger service parameter.

Once the lodging count or indicator has been included in the passenger service parameter at (344), at (346), the one or more processors can check if the flight delay exceeds a fourth threshold. The fourth threshold can be, for example, a threshold associated with providing transportation. For example, if a flight delay extends overnight, an airline may have a policy of providing transportation to the impacted passenger so that the impacted passenger can reach their overnight lodging destination. Additionally and/or alternatively, the fourth threshold can be any period of time. Further, in an embodiment, the fourth threshold can be set by a user, such as an airline or an airline employee. The one or more processors can be configured to determine a passenger service parameter by, for example, determining whether the impacted passenger's flight delay exceeds the fourth threshold. If the flight delay of the impacted passenger(s) does not exceed the fourth threshold, the one or more processors can, at (326) check to see if there are additional passengers on the spill list. If, however, the flight delay of the impacted passenger(s) does exceed the fourth threshold, the one or more processors can, at (348) include a transportation count or indicator in a passenger service parameter.

Once the transportation has been included in the passenger service parameter at (348), at (350), the one or more processors can check if the flight delay exceeds a fifth threshold. The fifth threshold can be, for example, a threshold associated with providing entertainment. For example, if a flight delay extends overnight, an airline may have a policy of providing entertainment to the impacted passenger. Additionally and/or alternatively, the fifth threshold can be any period of time. Further, in an embodiment, the fifth threshold can be set by a user, such as an airline or an airline employee. The one or more processors can be configured to determine a passenger service parameter by, for example, determining whether the impacted passenger's flight delay exceeds the fifth threshold. If the flight delay of the impacted passenger(s) does not exceed the fifth threshold, the one or more processors can, at (326) check to see if there are additional passengers on the spill list. If, however, the flight delay of the impacted passenger(s) does exceed the fifth threshold, the one or more processors can, at (352) include a lodging count or indicator in a passenger service parameter.

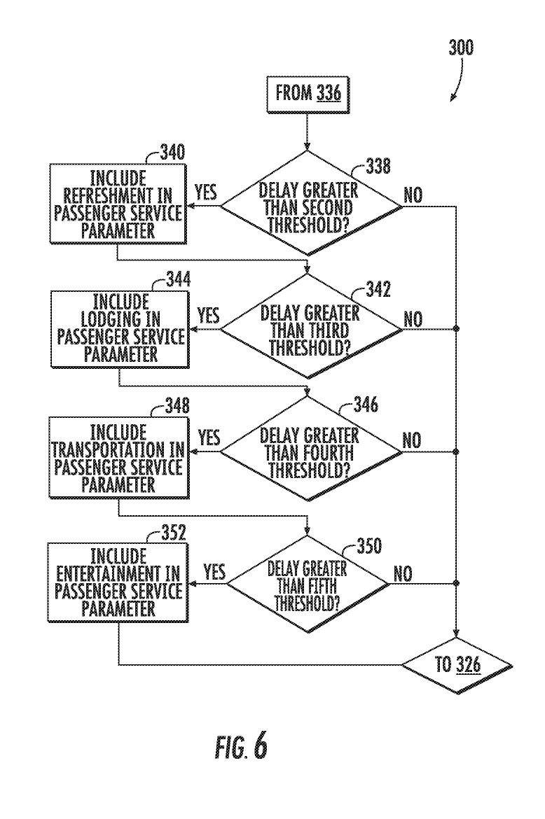

In an embodiment, additional thresholds not shown can be included in a method (300) for other passenger service parameters. In an embodiment, each threshold can be any period of time, and can be set by a user, such as an airline or an airline employee. Further, in an embodiment, a user, such as an airline, may decide to not include passenger service thresholds depicted in FIG. 6. Further, in an embodiment, the one or more processors can determine a passenger service parameter by determining that an impacted passenger or passengers need a particular passenger service. In another embodiment, the one or more processors can determine which passenger services are needed for each impacted passenger on a flight, and determine the total number of impacted passengers needing different categories of passenger services. In another embodiment, the one or more processors can determine that a passenger service is needed for a group of passengers travelling together and/or a group of passengers booked on a particular connecting flight. In yet another embodiment, the one or more processors can determine a cost associated with the passenger services needed by an impacted passenger by, for example, determining which passenger services are needed for an impacted passenger, and summing the costs of those services. Similarly, the one or more processors can determine an aggregate cost for all passenger services for all impacted passengers on a disrupted flight.

Once all threshold checks have been completed and all passenger services have been included in a passenger service parameter, at (326) the method (300) can include checking for additional passengers on the spill list. If so, the one or more processors can return to select another impacted passenger at (312). If not, at (354) the method can include outputting one or more passenger service parameters. For example, the one or more processors can send one or more signals to a display device in communication with the one or more processors to display the one or more passenger service parameters. For example, a passenger services parameter can be displayed in a flight parameter 160 in a display field 150 of a user interface 100. As shown, at (354), the passenger service parameter can be output if no additional passengers are on the impacted passenger list. In example embodiments, the one or more processors can output the passenger service parameter to display device viewable by a user (e.g., airline employee). However, in an embodiment, the passenger service parameter can be output at another time, such as after a passenger service parameter has been determined for one or more impacted passengers.

Further, in an embodiment, the method (300) can be performed by the one or more processors for each flight in a list of flights that fit the flight search parameters input by a user. For example, each flight can have one or more passenger service parameters displayed in a flight parameter 160 in a display field 150 of a user interface 100.

In one embodiment, the method (300) can include receiving, by the one or more processors, data indicating user selection to initiate the flight disruption. More specifically, the data can indicate the decision of a user (e.g., airline employee) to disrupt a flight. In response to receiving the data indicating the decision to initiate the flight disruption, the method (300) can include scheduling, by the one or more processors, an accommodation for the at least one impacted passenger. As will be discussed below in more detail, the accommodation can be based, at least in part, on the passenger service parameter determined for the at least one impacted passenger.

In example embodiments, the passenger service parameter for the at least one impacted passenger can include a voucher for lodging. As such, scheduling the accommodation can include determining, by the one or more processors, one or more providers of lodging services within a predetermined proximity. More specifically, the predetermined proximity can be a predetermined number of miles from an airport at which the at least one impacted passenger is located. In addition, scheduling the accommodation can include reserving, by the one or more processors, a room for the at least one impacted passenger at one of the providers of the lodging services. In addition, scheduling the accommodation can include notifying, by the one or more processors, the at least one impacted passenger of the accommodation. In particular, the notification can be any suitable notification (e.g., electronic mail, short message service (SMS) text, etc.).

Referring now to FIG. 7, an example system 400 according to example embodiments of the present disclosure is depicted. The system 400 can include one or more computing device(s) 402. The computing device(s) 402 can include one or more processor(s) 410 and one or more memory device(s) 420. The one or more processor(s) 410 can include any suitable processing device, such as a microprocessor, microcontroller, integrated circuit, logic device, and/or other suitable processing device. The one or more memory device(s) 420 can include one or more computer-readable media, including, but not limited to, non-transitory computer-readable media, RAM, ROM, hard drives, flash drives, and/or other memory devices.

The one or more memory device(s) 420 can store information accessible by the one or more processor(s) 410, including one or more tangible, non-transitory computer-readable instructions 422 that can be executed by the one or more processor(s) 410. The instructions 422 can be any set of instructions that when executed by the one or more processor(s) 410, cause the one or more processor(s) 410 to perform operations. In some embodiments, the instructions 422 can be executed by the one or more processor(s) 410 to cause the one or more processor(s) 410 to perform operations, such as any of the operations and functions for which the system 400 and/or the computing device(s) 402 are configured, the operations for determining a passenger service parameter for a flight disruption (e.g., methods 200 and 300), as described herein, and/or any other operations or functions of the one or more computing device(s) 402. The instructions 422 can be software written in any suitable programming language or can be implemented in hardware. Additionally, and/or alternatively, the instructions 422 can be executed in logically and/or virtually separate threads on processor(s) 410. The memory device(s) 420 can further store data 424 that can be accessed by the processor(s) 410. For example, the data 424 can include data indicative of a user selection of flight disruption criteria, and/or any other data and/or information described herein.

The computing device(s) 402 can also include a communication interface 430 used to communicate, for example, with the other components of system 400 or any devices in signal communication with a system 400, such as a display device configured to display a user interface. The communication interface 430 can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for determining a passenger service parameter for flight disruption, the system comprising:
one or more processors; and
one or more memory devices, the one or more memory devices storing instructions that when executed by the one or more processors cause the one or more processors to perform operations, the operations comprising:
receiving, by the one or more processors, data indicative of user selection of flight disruption criteria;
determining, by the one or more processors, at least one impacted passenger based at least upon the data indicative of the user selection;
determining, by the one or more processors, an alternate flight accommodation for the at least one impacted passenger;
determining, by the one or more processors, a flight delay for the at least one impacted passenger based at least upon the alternate flight accommodation; and
determining, by the one or more processors, a passenger service parameter associated with the at least one impacted passenger based at least upon the flight delay.

2. The system of claim 1, wherein the operations further comprise:
outputting, by the one or more processors, the passenger service parameter to a display device viewable by a user;
in response to outputting the passenger service parameter, receiving, by the one or more processors, data indicative of user selection to initiate the flight disruption; and
in response to receiving the data indicative of user selection to initiate the flight disruption, scheduling, by the one or more processors, an accommodation for the at least one impacted passenger based at least in part on the passenger service parameter.

3. The system of claim 2, wherein the passenger service parameter includes a voucher for lodging, and wherein the operation of scheduling the accommodation for the at least one impacted passenger further comprises:
determining, by the one or more processors, one or more providers of lodging services with a predetermined proximity; and
reserving, by the one or more processors, a room for the at least one impacted passenger at one of the providers of lodging services.

4. The system of claim 3, wherein scheduling the accommodation for the at least one impacted passenger further comprises:
notifying, by the one or more processors, the at least one passenger of the accommodation.

5. The system of claim 1, wherein a passenger service parameter is determined for each flight on the list of alternate flights.

6. The system of claim 1, wherein the flight disruption comprises a delayed flight.

7. The system of claim 1, wherein the flight disruption comprises a cancelled flight.

8. A computer-implemented method of determining a passenger service parameter for flight disruption, comprising:
receiving, by the one or more processors, data indicative of user selection of flight disruption criteria;
determining, by the one or more processors, at least one impacted passenger based at least upon the data indicative of the user selection;
determining, by the one or more processors, an alternate flight accommodation for the at least one impacted passenger;
determining, by the one or more processors, a flight delay for the at least one impacted passenger based at least upon the alternate flight accommodation; and
determining, by the one or more processors, a passenger service parameter associated the at least one impacted passenger based at least upon the flight delay.

9. The method of claim 8, wherein the method further comprises:
outputting, by the one or more processors, the passenger service parameter to a display device viewable by a user;
in response to outputting the passenger service parameter, receiving, by the one or more processors, data indicative of user selection to initiate the flight disruption; and
in response to receiving the data indicative of user selection to initiate the flight disruption, scheduling, by the one or more processors, an accommodation for the at least one impacted passenger based at least in part on the passenger service parameter.

10. The method of claim 9, wherein the accommodation comprises lodging for the at least one impacted passenger, and wherein scheduling the accommodations for the at least one impacted passenger further comprises:
determining, by the one or more processors, one or more providers of lodging services with a predetermined proximity; and
reserving, by the one or more processors, a room for the at least one impacted passenger.

11. The method of claim 8, wherein determining, by the one or more processors, an alternate flight accommodation for the at least one impacted passenger comprises determining, by the one or more processors, a final destination for the at least one impacted passenger.

12. The method of claim 11, wherein when an impacted passenger has a connecting flight, determining, by the one or more processors, an alternate flight accommodation comprises determining an alternate flight accommodation to the final destination for the impacted passenger.

13. The method of claim 11, wherein determining, by the one or more processors, an alternate flight accommodation comprises determining a list of flights to the final destination within a first threshold time period.

14. The method of claim 13, wherein when no alternate flight accommodation is available within a first threshold period of time, the impacted passenger comprises a spilled passenger.

15. The method of claim 8, wherein determining, by the one or more processors, a passenger service parameter associated with the at least one impacted passenger comprises determining a passenger service parameter for every impacted passenger on the disrupted flight.

16. The method of claim 8, further comprising determining, by the one or more processors, a list of alternate flights to the impacted passenger's destination within a first threshold time period based upon the data indicative of the user selection.

17. The method of claim 8, wherein when the flight delay exceeds a second threshold, the passenger service parameter comprises one or more meals or refreshments.

18. The method of claim 8, wherein when the flight delay exceeds a third threshold, the passenger service parameter comprises lodging

19. The method of claim 8, wherein when the flight delay exceeds a fourth threshold, the passenger service parameter comprises transportation.

20. The method of claim 8, wherein when the flight delay exceeds a fifth threshold, the passenger service parameter comprises entertainment.
